(19) United States
(12) Patent Application Publication
(10) Pub. No.: US 2012/0039582 A1
(43) Pub. Date: Feb. 16, 2012

(54) VERIFICATION AND SYNCHRONIZATION OF FILES OBTAINED SEPARATELY FROM A VIDEO CONTENT

(75) Inventors: Teck Wee Foo, Singapore (SG); Tek Seow Loi, Johor Bahru (MY)

(73) Assignee: KONINKLIJKE PHILIPS ELECTRONICS N.V., EINDHOVEN (NL)

(21) Appl. No.: 13/265,143

(22) PCT Filed: Apr. 13, 2010
(86) PCT No.: PCT/IB2010/051588

§ 371 Date: Oct. 19, 2011

(30) Foreign Application Priority Data
Apr. 20, 2009 (EP) 09158248.6

(51) Int. Cl. H04N 9/80; H04N 5/92

(52) U.S. Cl. 386/241; 386/239; 386/244; 386/E09.011; 386/E05.009

(57) ABSTRACT

The invention relates to a playback device for playback of a video content and of a file obtained separately from the video content. The invention is for a system wherein a file to be played with a movie is obtained from an uncontrolled source such as the Internet. Obtaining a file from such a source creates a number of issues due to the lack of control. The file obtained may not correspond to the intended movie or to the intended language and may not be synchronized with the movie. The invention proposes: 1) to verify that the separately obtained file corresponds to the movie; 2) if the separately obtained file corresponds to the movie, to determine whether it is synchronized with the movie; 3) if the separately obtained file is not synchronized with the movie, to synchronize it. The correspondence can be verified based on language, key phrases relating to the movie, or timing.

### FIELD OF THE INVENTION

The present invention relates to playback of a video content and of files obtained separately.

### BACKGROUND OF THE INVENTION

Subtitle files for movies can now be obtained separately from the movie with original audio track. The user that already has a movie with original audio track can search for and obtain subtitle files in other languages than those given with the movie. The same can be expected for audio files. Separate files for a movie can be downloaded from uncontrolled sources such as the Internet. Files related to a movie can be searched for and downloaded from a generic web site. Obtaining audio or subtitle files from such sources creates a number of issues due to the lack of control. The obtained files may not correspond to the movie that the user wants to watch, or to the intended language. The obtained files may also not be synchronized with the movie. To verify the correspondence between the obtained file and the movie, the user has to play the obtained file with the movie. The user has to repeat this verification for each file obtained until the intended file is found. Once the intended file is found, the user has to check the synchronization of the obtained file with the movie and to synchronize the obtained file manually if it is not synchronized with the movie. These are tedious and time consuming tasks for the user.

### SUMMARY OF THE INVENTION

The inventors of the present invention have appreciated that for files obtained separately from a video content, the solution to the above mentioned problems and possibly other problems is to first verify if the separately obtained files correspond to the video content and then to synchronize the files if needed.

Accordingly, the invention preferably seeks to mitigate, alleviate or eliminate one or more of the above mentioned disadvantages singly or in any combination.

The object of the present invention is obtained in a first aspect of the invention by providing a playback apparatus comprising:

Means for playback of a video content including a video file and an audio file, and of a file obtained separately from the video content; and

Means for determining whether the separately obtained file has a predefined correspondence to the video content; and

Means for determining, when it has been determined that the separately obtained file has the predefined correspondence to the video content, whether an element of the separately obtained file is synchronized with a corresponding element of the audio file of the video content; and

Means for synchronizing, if the element of the corresponding separately obtained file is not synchronized with the corresponding element in the audio file of the video content, the element of the separately obtained file with the corresponding element of the audio file of the video content.

The invention is particularly, but not exclusively, advantageous for use in connection with playback of multimedia content in the DVD format, DivX format, Blu-Ray format, and MKV format. The MKV format is the Video version of the Matroska Multimedia Container that is an open standard free container format that can hold an unlimited number of video, audio, picture or subtitle tracks inside a single file. Matroska file types are .MKV for video (with subtitles and audio), .MKA for audio-only files and .MKS for subtitles only.

It is an advantage of the present invention, that an effective way to handle files obtained separately is provided by first determining whether the separately obtained file has a predefined correspondence to the video content before proceeding further, so that the user need not to playback in vain each file obtained separately to determine a correspondence. Second, elements of the separately obtained file with the audio file of the video content are analyzed to determine and to synchronize non-synchronized elements, so that the user need not to search for another file or edit manually the obtained file to synchronize it with the video content.

In a second aspect, a method for verification and synchronization of a file obtained separately from a video content in accordance with the first aspect is provided. The method of the second aspect may in a third aspect be implemented in an integrated circuit (IC) for operating a playback apparatus in accordance with the first aspect.

In a fourth aspect, the invention relates to a computer program product being adapted to enable a computer system comprising at least one computer having data storage means associated therewith to control a playback apparatus according to the first aspect of the invention.

This aspect of the invention is particularly, but not exclusively, advantageous in that the present invention may be implemented by a computer program product enabling a computer system to perform the operations of the second aspect of the invention. Thus, it is contemplated that a playback apparatus may be changed to operate according to the present invention by installing a computer program product on a computer system controlling the playback apparatus. Such a computer program product may be provided on any kind of computer readable medium, e.g. magnetically or optically based medium, or through a computer based network, e.g. the Internet.

The various aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where:

FIG. 1 is a schematic view of a preferred implementation of a playback apparatus according to the present invention.

FIG. 2 is a flow-chart of a preferred implementation for operating a playback apparatus for playback of a video content and a separately obtained file.

FIG. 3 is a flow-chart for determining, based on a language analysis, a predefined correspondence of a separately obtained file with the video content.

FIG. 4 is a flow-chart for determining, based on a retrieved key phrase, a predefined correspondence of a separately obtained file with the video content.

FIG. 5 is a flow-chart for determining, based on timing, a predefined correspondence of a separately obtained file with the video content.

FIG. 6A is a flow-chart for determining whether an element of a separately obtained file is synchronized with a corresponding element of the audio file of the video content.

FIG. 6B is a flow-chart of a preferred implementation for synchronization based on modification of a timecode of a non-synchronized element of the separately obtained file.

FIG. 6C is a flow-chart of a preferred implementation for synchronization based on attribution of a timecode.

### DETAILED DESCRIPTION OF AN EMBODIMENT

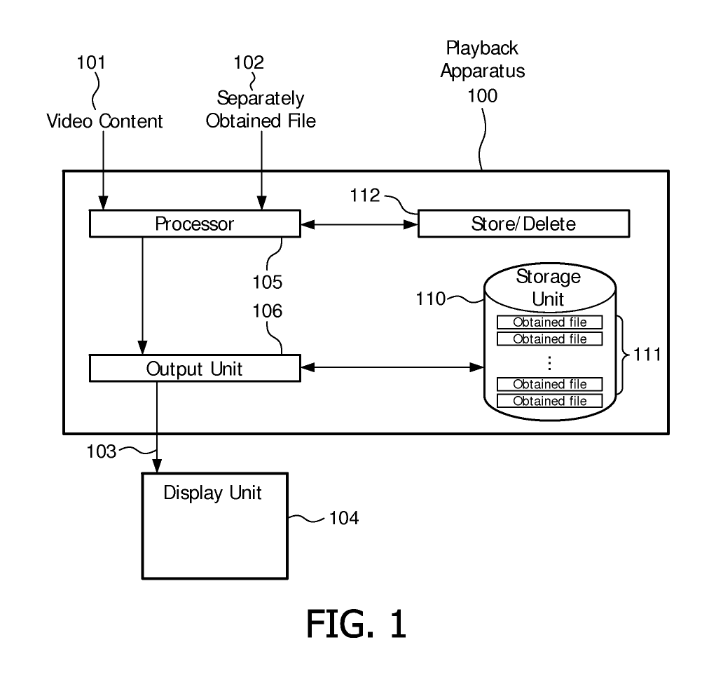

Referring to FIG. 1, a playback apparatus is shown therein, the playback apparatus being generally referred to by reference number 100. The playback apparatus 100 accepts a video content 101 and a separately obtained file 102. The video content includes a video file, one or more audio files (e.g. original audio file and audio files in other languages) and possibly one or more closed captions such as subtitle files. These files include elements marked with timecodes where elements are for example text elements for a subtitle file, or sound elements for an audio file. Elements of e.g. a subtitle file are individually synchronized to corresponding elements in an included audio file. The user may select to play the video content with the original audio file and a subtitle file that is in a language (e.g. French) different from the language (e.g. English) in the original audio file. The user may also select to play the video content with an audio file that is in a language (e.g. French) different from the language (e.g. English) in the original audio file.

The user may also decide to search for files that are not included in the video content in the user's possession. For example, the user may want to see the video content with subtitle files or audio files in a language (e.g. Italian) which is not included in the video content. The user would then search for and obtain separately subtitle files or audio files in the desired language (e.g. Italian) for the video content to be viewed.

The separately obtained file can be a subtitle file, a closed caption file or an audio file. The playback apparatus 100 comprises an output unit 106 that outputs a video and audio signal 103 to a viewing means, such as a display unit 104. The display unit 104 can be disposed remotely from the playback apparatus 100 as illustrated, or integrated with the playback apparatus 100. The playback apparatus has a processor 105 for controlling components thereof and carrying out instructions contained on hardware or software in the playback apparatus 100 or remote there from. The playback apparatus has a storage unit 110, such as a hard drive, for storing files thereon. The stored files comprise a plurality of files 111 obtained separately from the video content 101 through various sources such as Internet. The storage unit 110 is under the control of a store/delete agent 112 which instructs the storage unit to store or delete a given file. The store/delete agent 112 is under the control of the processor 105, and may be integrated therewith. In addition to the typical function of a processor 105 for a typical playback apparatus, the added functionalities of the processor will be described below in detail with regards to the present invention.

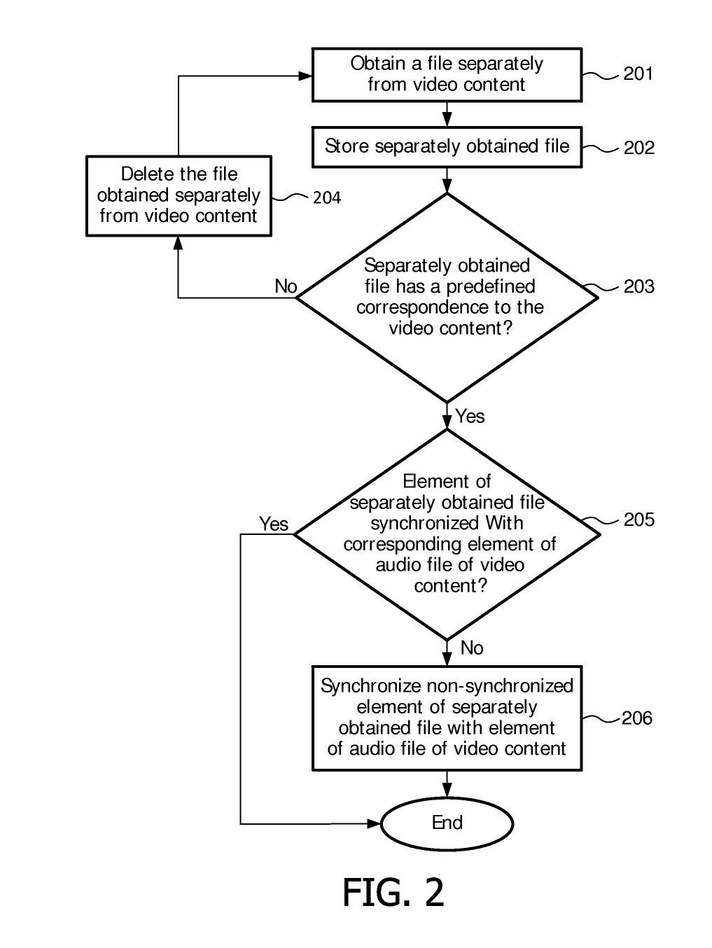

Referring to FIG. 2, there is a flowchart showing the main functionalities for verification and synchronization of separately obtained files. At step 201, a file is obtained separately from the video content. At step 202, the processor 105 stores the separately obtained file on the storage unit 110. The user can instruct the playback apparatus to store the separately obtained file. At step 203, the processor 105 determines whether the separately obtained file has a predefined correspondence to the video content. Various methods for determination of predefined correspondence will be described below in detail. If it is determined that the separately obtained file does not have a predefined correspondence to the video content, the processor 105 proceeds along path 203-NO to step 204 where the separately obtained file is deleted from the storage unit 110 and another file is obtained separately (step 201). In case of a plurality of files obtained separately from the video content, the plurality of separately obtained files is stored on the storage unit 110, and the processor 105 proceeds to the next separately obtained file that is stored for playback with the video content.

If it is determined that the separately obtained file has a predefined correspondence to the video content, the processor 105 proceeds along path 203-YES to step 205. At step 205, the processor 105 determines whether an element of the separately obtained file is synchronized with a corresponding element of the audio file of the video content. A preferred method for determining the synchronization between elements of the separately obtained file and corresponding elements of the audio file of the video content is described later. If it is determined that the separately obtained file does not contain any element that is not synchronized with a corresponding element of the audio file of the video content, the processor 105 proceeds along path 205-YES to end.

If it is determined that the separately obtained file contains an element of the separately obtained file that is not synchronized with a corresponding element of the audio file of the video content, the processor 105 proceeds along path 205-NO to step 206. At step 206, the processor 105 synchronizes the non-synchronized element of the separately obtained file with the corresponding element in the audio file of the video content. Synchronization relates to the time coordination of the elements in both files. A threshold of tolerance is taken into account in determining and performing synchronization of elements. Methods for synchronizing non-synchronous elements of the separately obtained file are described later.

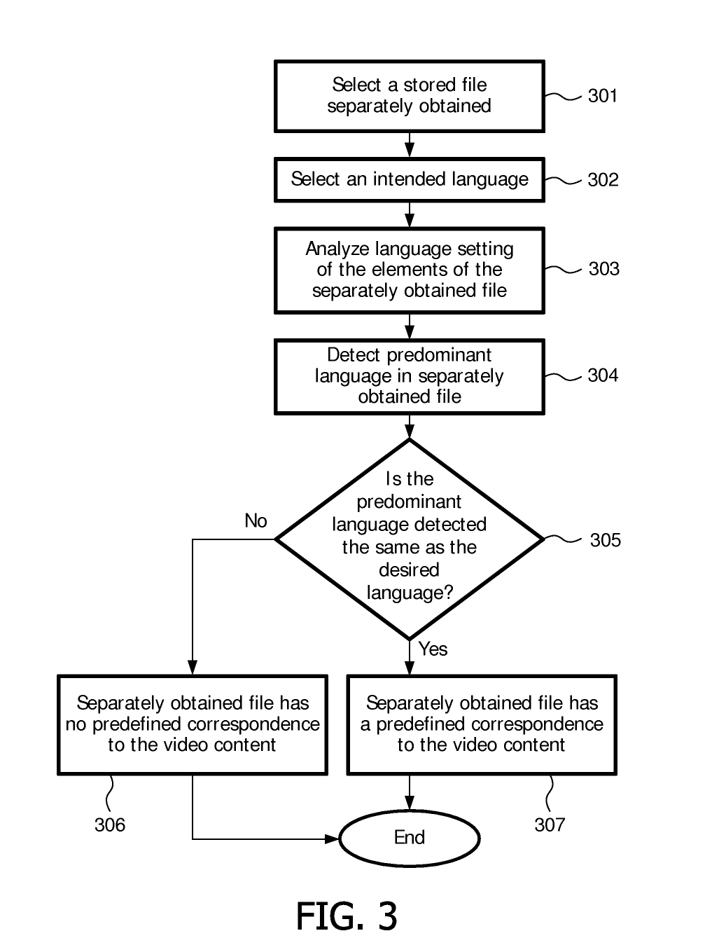

Referring to FIG. 3, there is a flowchart showing a preferred implementation of the functionality for determining a predefined correspondence of a separately obtained file based on an intended language. At step 301, the processor 105 selects a separately obtained file stored on the storage unit 110. At step 302, the user selects an intended language for which the separately obtained file should be verified. At step 303, the processor 105 analyzes the language setting of the elements of the separately obtained file and proceeds to step 304 where it detects a predominant language present in the separately obtained file. At step 305, the processor determines whether the predominant language detected is the same as the intended language. If it is determined that the predominant language detected is not the same as the intended language, the processor 105 proceeds along path 305-NO to step 306 where the separately obtained file is marked as having no predefined correspondence to the video content. If it is determined that the predominant language detected is the same as the intended language, the processor 105 proceeds along path 305-YES to step 307 where the separately obtained file is marked as having the predefined correspondence to the video content.

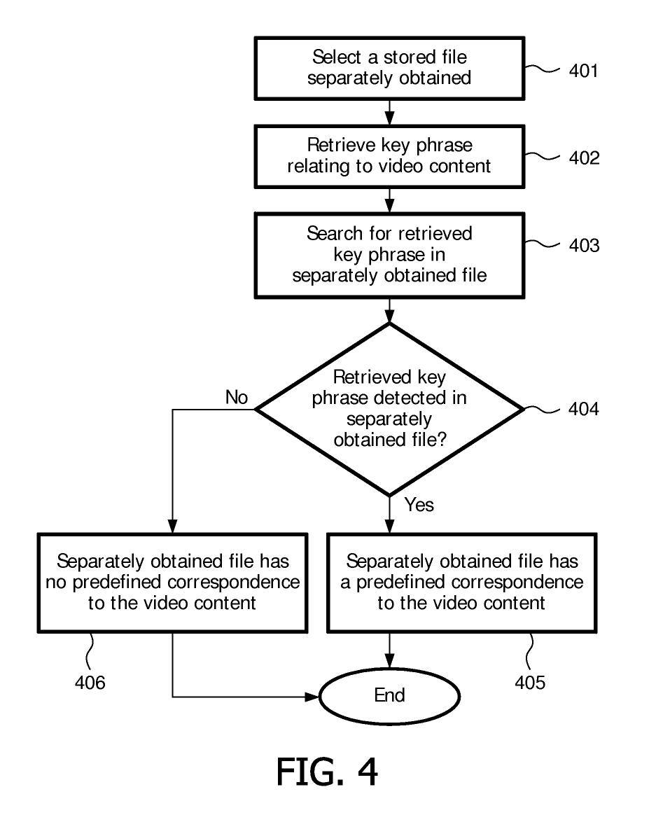

Referring to FIG. 4, there is a flowchart showing a preferred implementation of the functionality for determining a predefined correspondence of a separately obtained file based on a retrieved key phrase relating to the video content. At step 401, the processor 105 selects a separately obtained file stored on the storage unit 110. At step 402, the processor 105 retrieves a key phrase relating to the video content. The key phrase could be retrieved from a separate source of information like a website on the Internet or from any file included in the video content (e.g. audio file, subtitle file, extra features). At step 403, the processor 105 searches for the retrieved key phrase in the separately obtained file. At step 404, the processor determines whether the retrieved key phrase is present in the separately obtained file. If it is determined that the retrieved key phrase is not present in the separately obtained file, the processor 105 proceeds along path 404-NO to step 405 where the separately obtained file is marked as having no predefined correspondence to the video content. If it is determined that the retrieved key phrase is present in the separately obtained file, the processor 105 proceeds along path 404-YES to step 406 where the separately obtained file is marked as having the predefined correspondence to the video content.

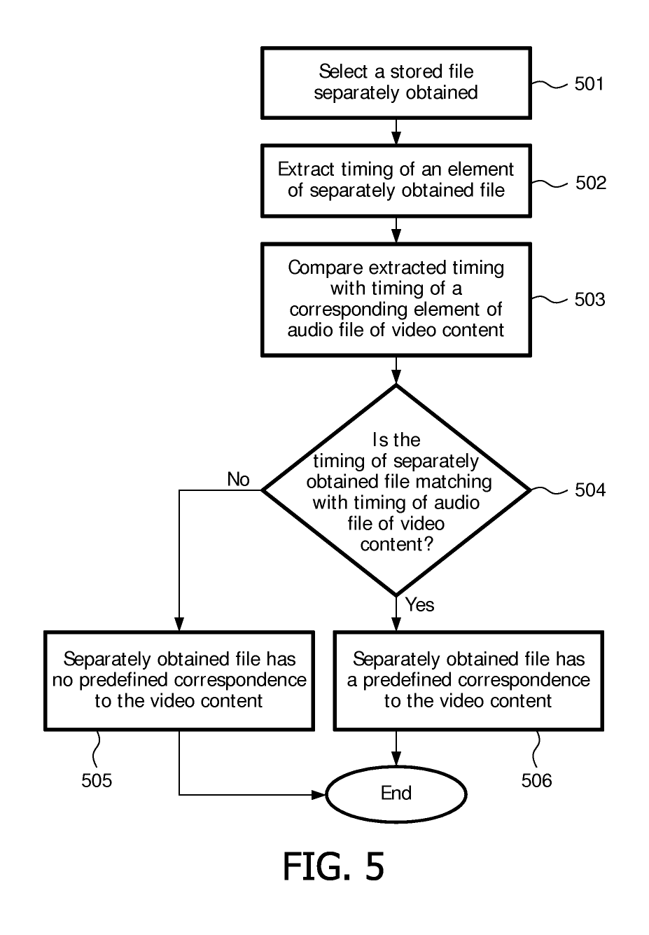

Referring to FIG. 5, there is a flowchart showing a preferred implementation of the functionality for determining a predefined correspondence of a separately obtained file based on timing. At step 501, the processor 105 selects a separately obtained file stored on the storage unit 110. At step 502, the processor 105 extracts timing of an element of the separately obtained file. At step 503, the processor 105 compares the extracted timing with timing of a corresponding element of the audio file of the video content. At step 504, the processor 105 determines whether the result of the comparison establishes a correspondence between the separately obtained file and the video content. For example, if the comparison result reveals a difference in timing that is within predefined limits, then the correspondence between both files is established; else the correspondence is not established. If it is determined that the result of the comparison does not establish a correspondence between the separately obtained file and the video content, the processor 105 proceeds along path 504-NO to step 505 where the separately obtained file is marked as having no predefined correspondence to the video content. If it is determined that the result of the comparison establishes a correspondence between the separately obtained file and the video content, the processor 105 proceeds along path 504-YES to step 506 where the separately obtained file is marked as having the predefined correspondence to the video content.

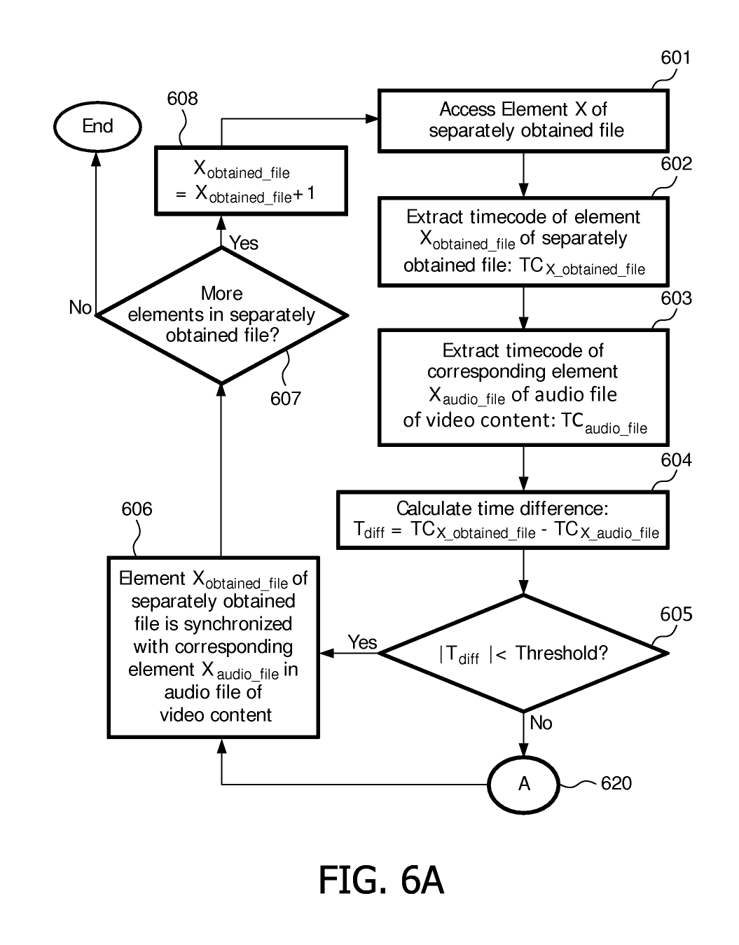

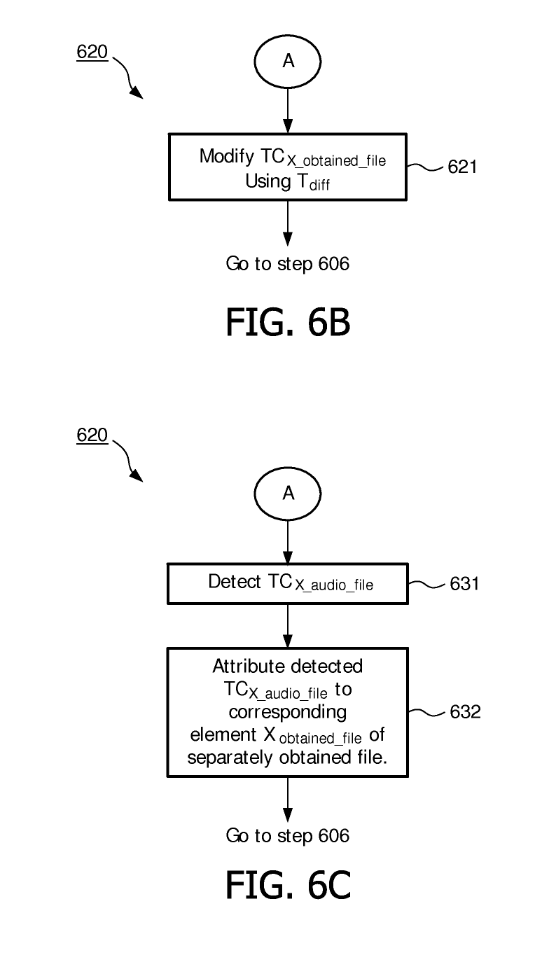

Referring to FIG. 6A, there is a flowchart showing a preferred implementation of the functionality for determining whether an element of a separately obtained file is synchronized with a corresponding element of the audio file of the video content. At step 601, the processor 105 accesses an element, denoted by the index X_{obtained}_{_{—}}_{file}, of the separately obtained file to be examined. At step 602, the processor 105 extracts the timecode TC_{X}_{_{—}}_{obtained}_{_{—}}_{file} of the element of the separately obtained file. At step 603, the processor 105 extracts the timecode TC_{X}_{_{—}}_{audio}_{_{—}}_{file} of the corresponding element X_{audio}_{_{—}}_{file} of the audio file of the video content. At step 604, the processor 105 calculates the time difference T_{diff} between the timecode of the element of the separately obtained file and the timecode of the corresponding element of the audio file of the video content:

T_{diff}=TC_{X}_{_{—}}_{obtained}_{_{—}}_{file}−TC_{X}_{_{—}}_{audio}_{_{—}}_{file}

At step 605, the processor 105 determines whether the absolute time difference T_{diff} calculated is below a predefined threshold. If it is determined that the absolute time difference calculated is below the predefined threshold, the processor 105 proceeds along path 605-YES to step 606 where the element X_{obtained}_{_{—}}_{file} of the separately obtained file is marked as synchronized to the corresponding element X_{audio}_{_{—}}_{file} of the audio file of the video content. If it is determined that the absolute time difference calculated is not below the predefined threshold, the processor 105 proceeds along path 605-NO to routine 620. Routine 620 is shown in FIG. 6B and 6C depicting two alternative techniques preferred for synchronizing non-synchronized elements.

At step 607, the processor 105 determines whether there are any remaining elements of the separately obtained file to be examined. If it is determined that there are remaining elements in the separately obtained file, the processor 105 proceeds along path 607-YES to step 608 where the index X_{obtained}_{_{—}}_{file} of the element of the separately obtained file is incremented by 1 to equal the index of the next element in the sequence of the separately obtained file.

Referring to FIG. 6B, routine 620 is illustrated therein. At step 621, the processor 105 modifies the timecode TC_{X}_{_{—}}_{obtained}_{_{—}}_{file} of the element of the separately obtained file so that time difference between TC_{X}_{_{—}}_{obtained}_{_{—}}_{file} and TC_{X}_{_{—}}_{audio}_{_{—}}_{file} is within the predefined threshold. The processor 105 then proceeds to step 606.

Referring to FIG. 6C, an alternative routine 620 is illustrated therein. At step 631, the processor 105 detects the timecode TC_{X}_{_{—}}_{audio}_{_{—}}_{file} of the element X_{audio}_{_{—}}_{file} of the audio file of the video content that corresponds to the accessed element X_{obtained}_{_{—}}_{file} of the separately obtained file. At step 632, the processor 105 attributes the detected timecode TC_{X}_{_{—}}_{audio}_{_{—}}_{file} to the corresponding element X_{obtained}_{_{—}}_{file} of the separately obtained file. The processor 105 then proceeds to step 606.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A Playback apparatus comprising:
Means for playback of a video content including a video file and an audio file, and of a file obtained separately from the video content; and
Means for determining whether the separately obtained file has a predefined correspondence to the video content; and
Means for determining, when it has been determined that the separately obtained file has the predefined correspondence to the video content, whether an element of the separately obtained file is synchronized with a corresponding element of the audio file of the video content; and
Means for synchronizing, when it has been determined that the element of the corresponding separately obtained file is not synchronized with the corresponding element in the audio file of the video content, the element of the separately obtained file with the corresponding element of the audio file of the video content.

2. The apparatus according to claim 1, wherein the separately obtained file from the video content is a subtitle file, a closed caption file, or an audio file.

3. The apparatus according to claim 1, wherein the means for determining whether the separately obtained file has a predefined correspondence to the video content comprise:
Means for analyzing a language setting of the separately obtained file; and
Means for detecting a language predominantly present in the separately obtained file.

4. The apparatus according to claim 3, wherein the means for detecting a language predominantly present in the separately obtained file further comprise means for detecting whether an intended language is the language detected as predominantly present in the separately obtained file.

5. The apparatus according to claim 1, wherein the means for determining whether the separately obtained file has a predefined correspondence to the video content comprise:
Means for comparing a timing of an element of the separately obtained file with a timing of a corresponding element in the audio file of the video content; and
Means for analyzing results of the comparison to establish a correspondence between the separately obtained file and the video content.

6. The apparatus according to claim 1, wherein the means for determining whether the separately obtained file has a predefined correspondence to the video content comprise:
Means for retrieving a key phrase relating to the video content; and
Means for detecting whether the retrieved key phrase is present in the separately obtained file.

7. The apparatus according to claim 1, wherein the means for determining whether an element of the separately obtained file is not synchronized with a corresponding element of the audio file of the video content comprise:
Means for calculating a time difference between a timecode of the element of the separately obtained file and a timecode of the corresponding element of the audio file of the video content; and
Means for comparing the time difference calculated with a predefined threshold, wherein if the absolute time difference calculated is not below the predefined threshold then the element of the separately obtained file is determined to be non-synchronized with the corresponding element of the audio file of the video content.

8. The apparatus according to claim 1, wherein the means for synchronizing a non-synchronized element of the separately obtained file with a corresponding element of the audio file of the video content, comprise:
Means for calculating a time difference between a timecode of the non-synchronized element of the separately obtained file and a timecode of the corresponding element of the audio file of the video content; and
Means for modifying the timecode of the non-synchronized element of the separately obtained file so that the time difference is within a predefined limit.

9. The apparatus according to claim 1, wherein the means for synchronizing a non-synchronized element of the separately obtained file with a corresponding element of the audio file of the video content, comprise:
Means for detecting a timecode of the element of the audio file of the video content; and
Means for attributing the detected timecode of the element of the audio file of the video content to the corresponding element of the separately obtained file.

10. Method for verification and synchronization of a file obtained separately from a video content including a video file and an audio file, the method comprising:
determining whether the separately obtained file has a predefined correspondence to the video content; and
if it has been determined that the separately obtained file has the predefined correspondence to the video content, determining whether an element of the separately obtained file is synchronized with a corresponding element of the audio file of the video content; and
if it has been determined that the element of the corresponding separately obtained file is not synchronized with the corresponding element in the audio file of the video content, synchronizing the element of the separately obtained file with the corresponding element of the audio file of the video content.

11. Integrated circuit (IC) for operating a playback apparatus in accordance with claim 10.

12. A computer program product embodied in a computer-readable medium for operating a playback apparatus in accordance with claim 10.
